(19) United States
(12) Patent Application Publication
(10) Pub. No.: US 2025/0354640 A1
(43) Pub. Date: Nov. 20, 2025

(54) MANIFOLD AND FITTING FOR GAS DISTRIBUTION SYSTEM

(71) Applicant: M.B. Sturgis, Inc., Maryland Heights, MO (US)

(72) Inventor: Rosemary Diel, O'Fallon, MO (US)

(21) Appl. No.: 19/213,721

(22) Filed: May 20, 2025

Related U.S. Application Data
(60) Provisional application No. 63/649,824, filed on May 20, 2024.

(51) Int. Cl. F16L 41/03; F16L 37/248

(52) U.S. Cl. CPC F16L 41/03; F16L 37/248

(57) ABSTRACT

A gas distribution system configured to distribute gas from a source to a plurality of gas-powered appliances is disclosed. The system includes gas hoses or lines interconnected by manifolds for directing the gas from the tank to the individual appliances. The hoses and other components are coupled to the manifolds by component fittings which enable the hoses and other components to be quickly and readily connected and disconnected from the manifolds. In this way, the system may be assembled and/or repaired more quickly and easily. The system may be configured to be retained on a mobile platform, such as a recreational vehicle.

### CROSS-REFERENCE TO RELATED APPLICATION

This application claims priority to U.S. Provisional Patent Application No. 63/649,824, filed May 20, 2024, the entire disclosure of which is incorporated herein by reference.

### FIELD OF THE DISCLOSURE

The present disclosure generally relates to a manifold and a fitting for a gas distribution system.

### BACKGROUND OF THE DISCLOSURE

A gas distribution system is used to distribute gas from a source (e.g., a tank) to a plurality of gas-powered appliances (e.g., stove, oven, furnace, water heater). The gas distribution system includes gas hoses or lines interconnected by manifolds for directing the gas from the tank to the individual appliances. As an example, a suitable propane distribution system is utilized in recreational vehicles (RVs).

### BRIEF DESCRIPTION OF THE DRAWINGS

FIG. 1 is a perspective view of one embodiment of a gas distribution system including manifolds interconnecting a plurality of gas hoses or lines.

FIG. 2 is a perspective of one of the manifolds, including fittings coupled thereto, with some components of the hose removed for illustrative purposes.

FIG. 3 is a top plan view of FIG. 2.

FIG. 4 is a bottom plan view of FIG. 2.

FIG. 5 is a perspective of the manifold.

FIG. 6 a perspective cross section of the manifold taken through the line 6-6 in FIG. 5.

FIG. 7 is a longitudinal section of the manifold.

FIG. 8 is a perspective of the fitting.

FIG. 9 is a front elevation of the fitting.

FIG. 10 is a perspective cross section of the manifold taken through the line 1010 in FIG. 4.

FIG. 11 is a longitudinal section of the manifold including the hose fittings coupled thereto.

FIG. 12 is similar to FIG. 3, with one of the hose fittings exploded from the manifold.

FIG. 13 is a perspective of one of the manifolds of FIG. 1 with a plug exploded therefrom.

FIG. 14 is a perspective of one of the manifolds FIG. 1 with a gas tank coupler exploded therefrom.

### DETAILED DESCRIPTION OF THE DISCLOSURE

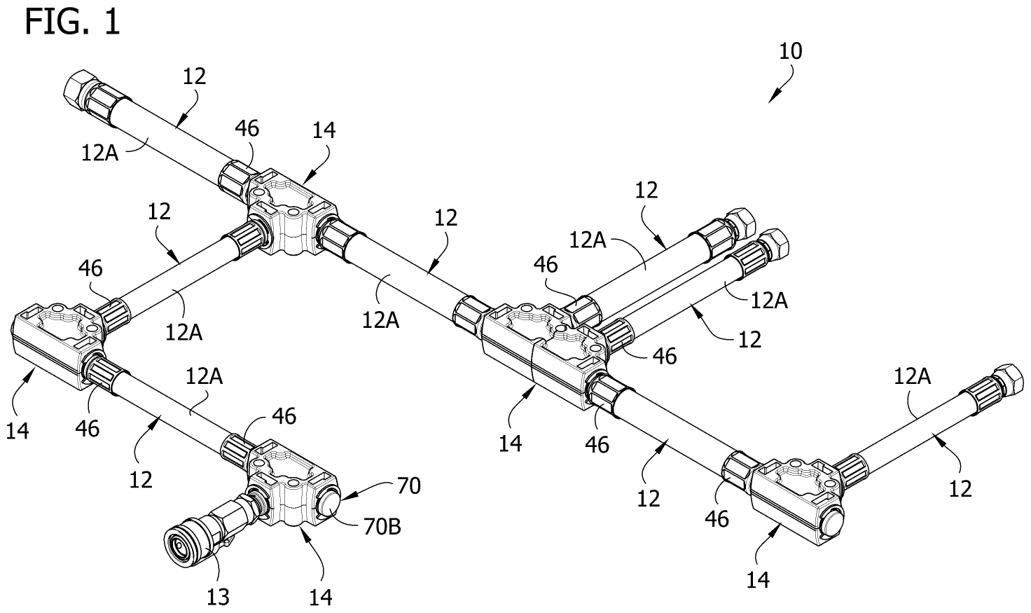

Referring to FIG. 1, an exemplary gas distribution system (broadly, system) configured to distribute gas (e.g., propane) from a source (e.g., a tank) to a plurality of gas-powered appliances (e.g., stove, oven, furnace, water heater) is generally indicated at reference number 10. The system 10 includes gas hoses or lines 12 interconnected by manifolds, each generally indicated at reference number 14, for directing the gas from the tank to the individual appliances. As will be explained in greater detail below, the hoses 12 and other components are coupled to the manifolds 14 by component fittings (broadly, fittings) which enable the hoses and other components to be quickly and readily connected and disconnected from the manifolds. In this way, the system 10 is capable of being assembled more quickly and easily, and repairs and replacements to the system 10 may also be made more quickly and easily. In certain embodiments, the system 10 is configured to be retained on a vehicle or other mobile platform, such as a recreational vehicle (RV).

Referring to the illustrated embodiment of FIG. 1, the manifolds 14 are configured to releasably couple to any number of components of the system 10, such as hoses 12 or a tank coupler 13. The number of hoses 12 and manifolds 14 are easily adjusted (e.g., added, removed, substituted) to meet the needs (e.g., gas delivery requirements, space restraints) of the one or more gas-powered appliances to which the system 10 is configured to deliver gas. For example, there may be a plurality of hoses 12, such as two, three, four, or more hoses. The illustrated system 10 includes four manifolds 14 configured to couple to three hoses 12 (i.e., three-port manifolds), and a single manifold configured to couple to four hoses (i.e., a four-port manifold). Other than the number of ports, the manifolds 14 are essentially identical. As explained below, three of the three-port manifolds 14 include a port that is plugged with a plug 70 (e.g., stopped, sealed) to configure the manifolds as two-port manifolds. Moreover, the tank coupler 13 is coupled to one of the two-part manifolds 14. Other configurations of the manifolds 14 and components (e.g., hoses 12, tank coupler 13, plugs 70) for forming the system 10 are included within the scope of the present disclosure. For ease of explanation, the four-port manifold 14 is shown in detail and explained herein. As disclosed above, the features of the four-part manifold 14 apply equally to all manifolds of the present disclosure, regardless of the number of ports.

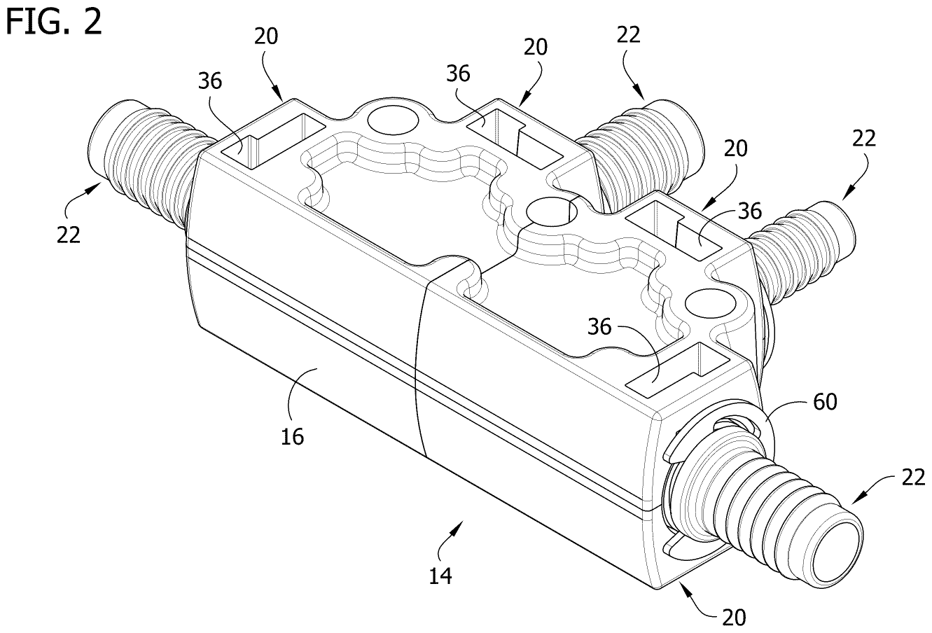

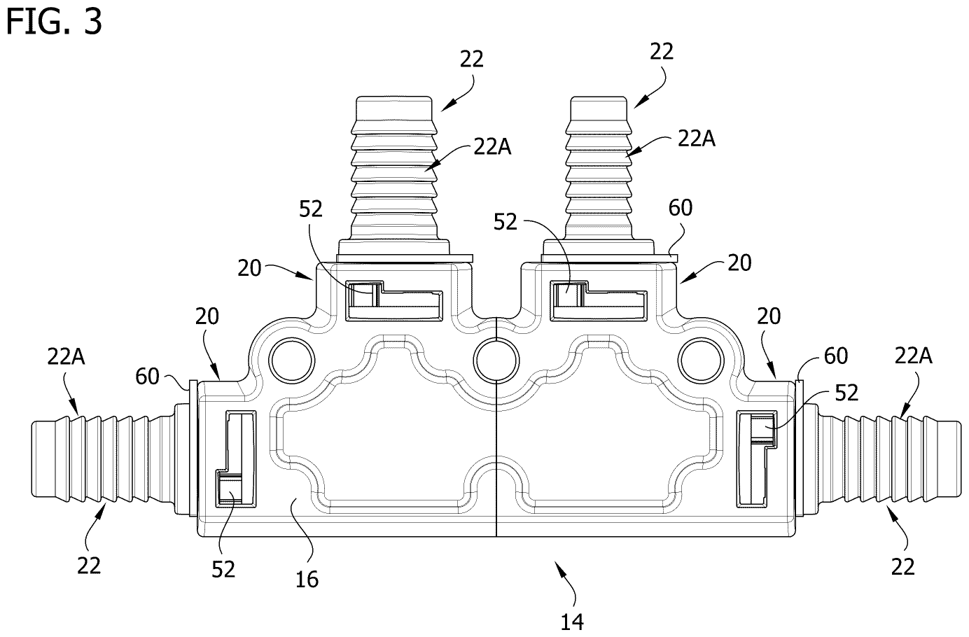

Referring to FIGS. 2-4, the manifold 14 includes a manifold body 16 and ports, each generally indicated at reference numeral 20, configured to receive and sealingly couple to a hose fitting, each generally indicated at reference numeral 22 (or other fitting, as explained below). In particular, the ports 20 and the hose fittings 22 (and other fittings) are couplable by a bayonet-type connection. The illustrated manifold 14 includes two coaxial ports 20 on opposing ends of the manifold (e.g., end ports) and two parallel ports on a shared side of the manifold (e.g., side ports).

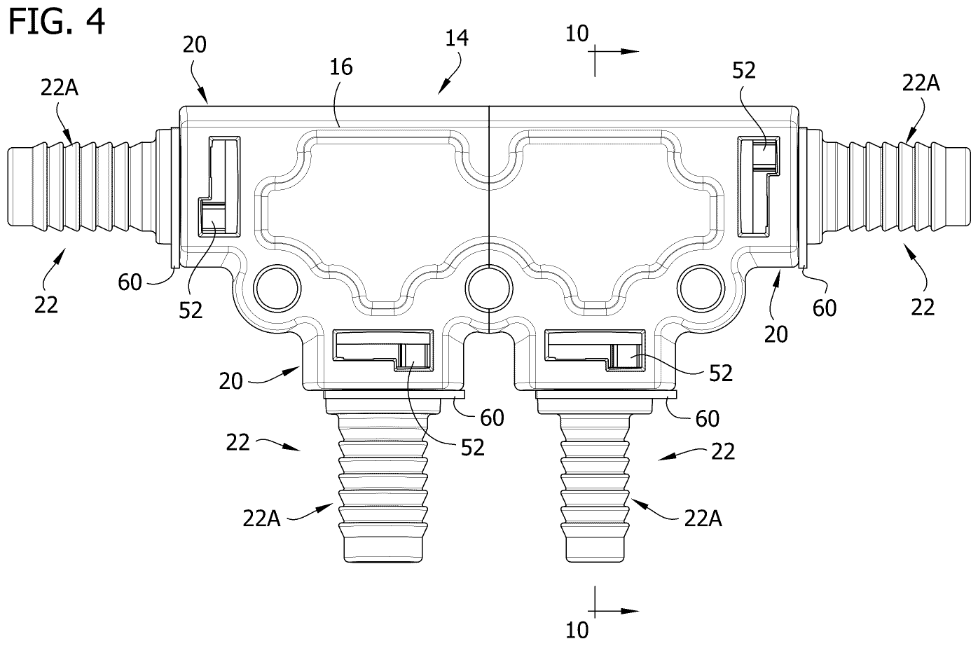

In one example, the manifold body 16 is a two-part assembly constructed from one or more rigid materials that may be both lightweight and durable. For example, individual portions of the manifold body 16 may be molded from a plastic material (e.g., high-density polyethylene, low-density polyethylene, polycarbonate, polyoxymethylene, methyl methacrylate, thermoplastic polyurethane, thermoplastic rubber, polypropylene, etc.) and subsequently combined to form the manifold body as illustrated. In their combination, the individual portions are adhered (e.g., using an adhesive) and secured (e.g., using fasteners) to ensure that the interior of the manifold 14 is hermetically sealed, and gas leaks are therefore prevented. In alternative embodiments, the manifold body 16 is molded as a one-piece, integrally formed component. The manufacturing process may include the addition of insignia or other identifying marks on an external surface of the manifold body 16, including a part number (see FIG. 4) or information regarding the use of manifold 14 (e.g., a pressure rating, a port size, etc.). In other embodiments, the manifold body may be formed from a metal material or other suitable materials.

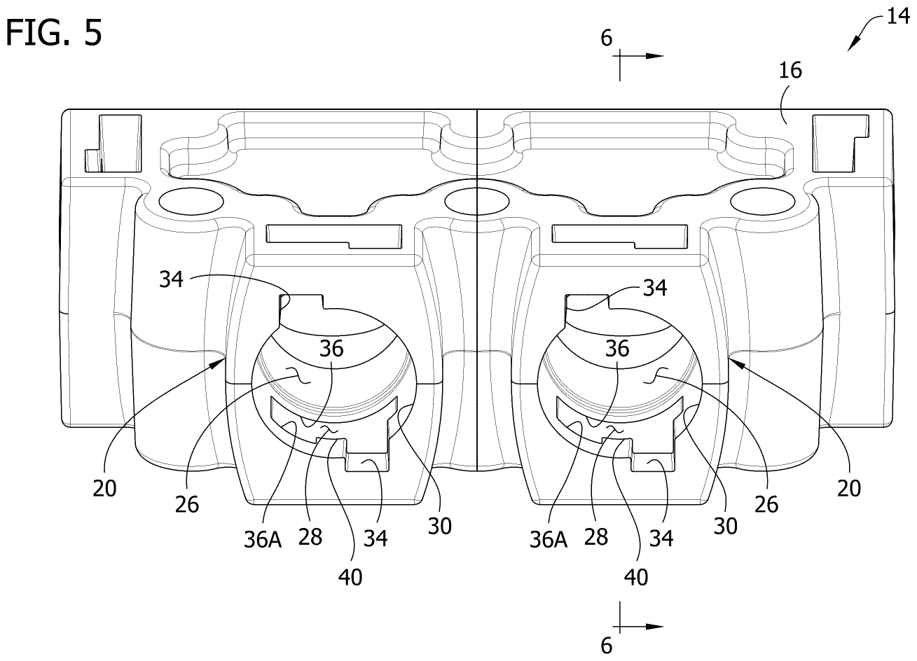

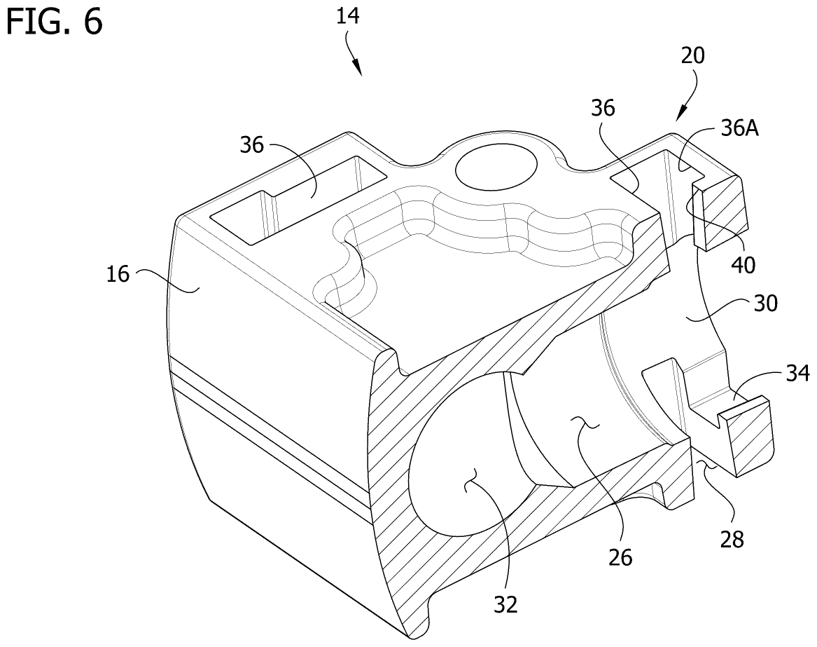

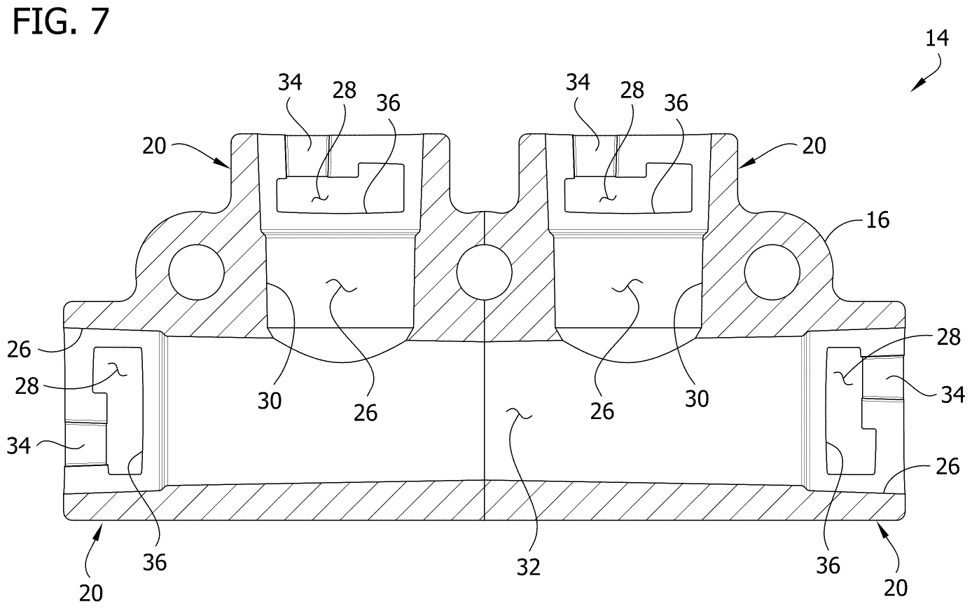

Referring to FIGS. 5-7, each port 20 includes a port opening 26 and diametrically opposed bayonet slots 28 (e.g., L-shaped slots) extending from and in registration with the port opening. Each port opening 26 is defined by a generally cylindrical internal surface 30, and extends axially from a front of the port 20 to an interior of the manifold body 16 where it is in fluid communication with a manifold passage 32 which fluidly connects the ports (see FIGS. 6 and 7). Each of the bayonet slots 28 includes an ingress portion 34 extending through the front of the port 20 that leads to a transverse locking portion 36 that is spaced from the front of the port and extends generally transverse (e.g., orthogonal) to the ingress portion (thus forming a generally L-shaped slot). The transverse locking portion 36 extends along a circumferential portion of the port opening 26 and has opposite first and second arc ends. The ingress portion 34 leads into or adjacent to the first arc end. The second arc end and an internal shoulder or stop 40 projecting rearward defines a serif portion 36A of the illustrated L-shaped bayonet slot 28. The transverse locking portions 36 of the bayonet slots 28 extend through upper and lower surfaces of the manifold body 16 to provide windows for viewing the hose fittings 22 in the ports 20.

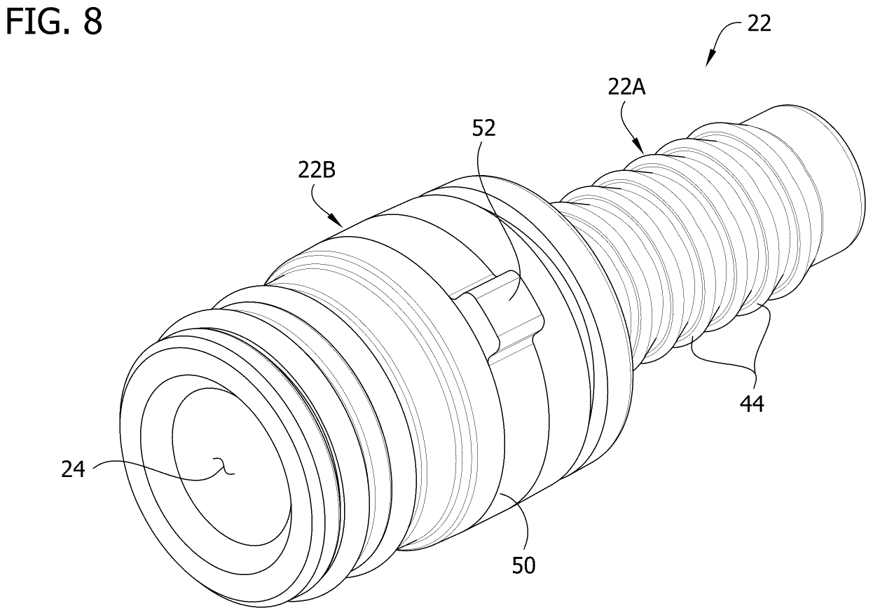

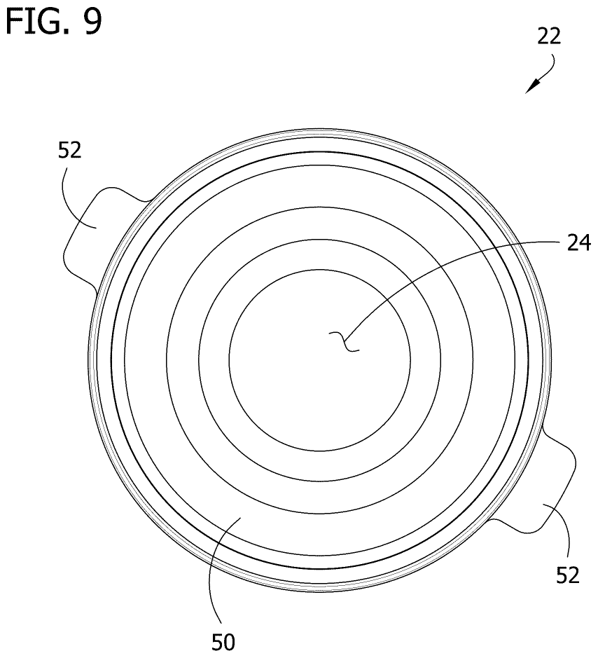

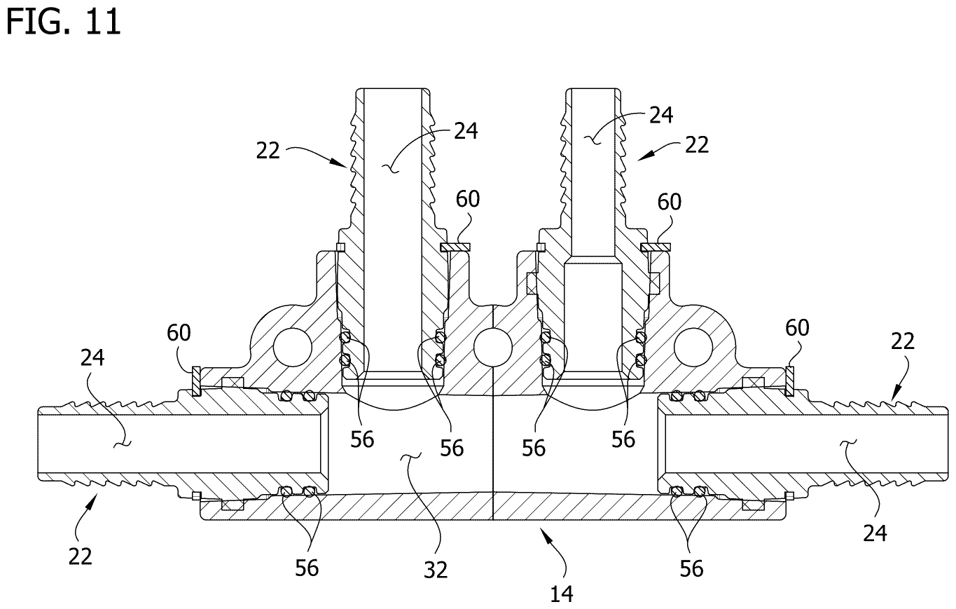

Referring to FIGS. 8-11, each hose fitting 22 defines a fluid passage 24 extending between opposite proximal and distal end portions of the fitting. The hose fitting 22 includes a hose connector, generally indicated at reference numeral 22A, at the proximal end portion of the fitting. The hose connector 22A is configured to couple to a hose body 12A of the hose 12. The hose fitting 22 also includes a manifold connector, generally indicated at reference numeral 22B, at the distal end portion of the fitting. The manifold connector 22B is configured to couple to the ports 20 of the manifold 14. In the illustrated embodiment, the hose connector 22A is insertable into an end of the hose 12. The hose connector 22A includes a plurality of annular ribs 44 (e.g., barbs) spaced apart longitudinally thereon. A cylindrical skirt 46 (see FIG. 1) is crimped onto the hose 12 to sandwich the end of the hose between the barbs 44 and the skirt, thereby securing the hose fitting 22 to the hose. When secured to the hose 12, the fluid passage 24 of the hose fitting 22 is in fluid communication with the hose.

In one or more other embodiments, the hose fitting 22 may be secured to the hose 12 in other ways using other types of connections. As shown in FIG. 1, each hose 12 includes hose fittings 22 secured to one or both ends of the hose, depending on whether the particular hose is used to fluidly connect separate manifolds 14—whereby each end of the hose includes the hose fittings—or is used to connect a manifold to an appliance—whereby one end of the hose includes the hose fitting and the other end of the hose includes an alternative fitting for coupling to an appliance, for example—.

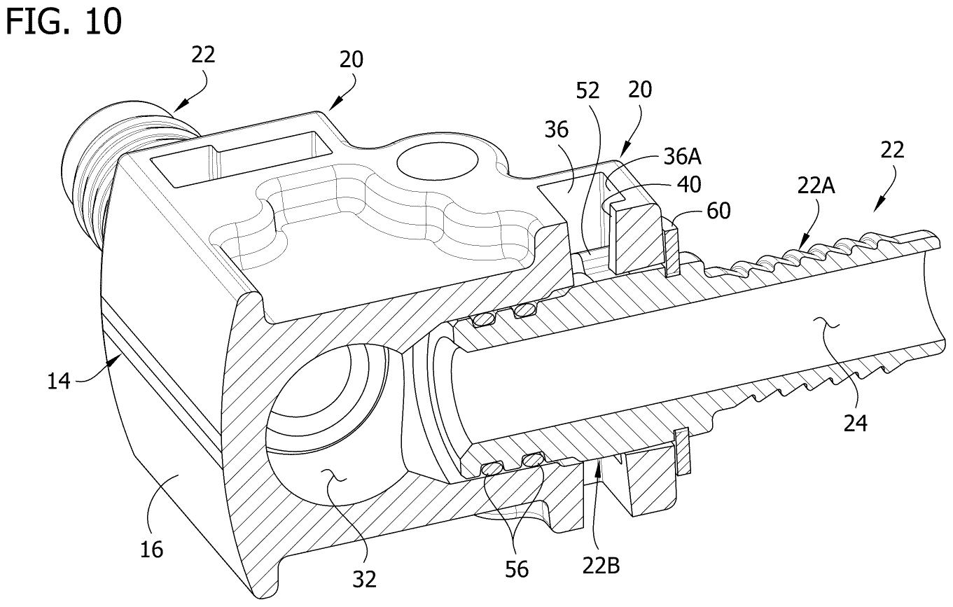

Referring to FIGS. 10-12, the manifold connector 22B of the hose fitting 22 is configured to be inserted into any of the ports 20 of the manifold 14 and subsequently locked in the port by rotating the fitting relative to the port (e.g., in a clockwise direction). The manifold connector 22B includes a substantially cylindrical connector body 50 sized and shaped to be received into the port opening 26, and at least one (e.g., two) bayonet pins 52 extending radially or laterally outward from the connector body. The manifold connector 22B also includes at least one annular seal 56 (e.g., O-ring) received on the connector body 50. In the illustrated embodiment, the manifold connector 22B includes two resiliently compressible O-rings 56 which are disposed distal of the bayonet pins 52. The annular seal(s) 56 may be received in a circumferential groove defined by the connector body 50 to prevent longitudinal migration of the annular seal(s) during insertion or removal of the fitting 22 from the port 20. The annular seal(s) are configured to sealingly engage the smooth, generally cylindrical internal surface 30 defining the port opening 26 to inhibit gas from leaking out the manifold 14.

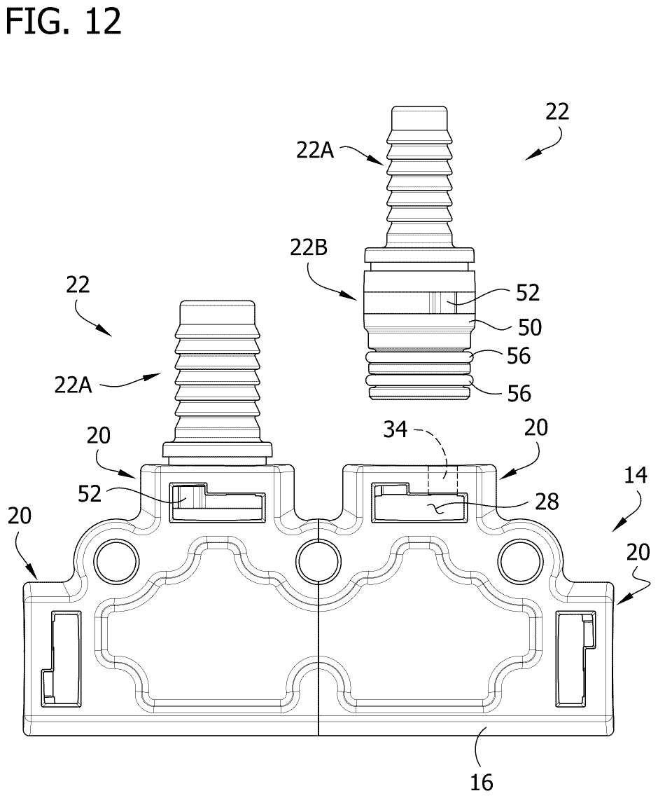

In the illustrated embodiment, the manifold connector 22B includes two bayonet pins 52 which are generally diametrically opposed from one another on the connector body 50. The bayonet pins 52 are configured to be alignable with and insertable through the ingress portions 34 and into the transverse locking portions 36 of the bayonet slots 28 when axially inserting the hose fitting 22 into the port 20, as shown in FIG. 12. With the bayonet pins 52 are received in the transverse locking portions 36 of the bayonet slots 28, rotation of the fitting 22 moves the pins 52 along the arc lengths of the transverse locking portions toward the second arc ends of the transverse locking portions. Once the bayonet pins 52 are at the second arc ends of the transverse locking portions 36, moving the hose fitting 22 axially in a forward direction (i.e., partially retracting the fitting) moves the pins into the serif portions 36A of the bayonet slots 28 to connect the fitting 22 to the port 20. In one example, a clip 60 (e.g., C-clip or E-clip) is then clipped onto the hose fitting 22 (while the fitting is partially retracted), such as by clipping the clip into a circumferential channel defined by the hose fitting between the hose connector 22A and the manifold connector 22B (proximal of the at least one bayonet pin). The clip 60 engages the front of the port 20 and inhibits the hose fitting 22 from axially moving rearward in the port (e.g., from being reinserted). In this way, the bayonet pins 52 are captured between the stops 40 and the second arc ends of corresponding transverse locking portions 36, and the fitting 22 is incapable of rotating to an extent that would align the pins with the ingress portions 34 of the bayonet slots 28. Thus, the fitting 22 is locked in the port 20 (i.e., is longitudinally and rotatably fixed) while the clip 60 is attached thereto.

To remove the fitting 22 from the port 20 (e.g., to unlock the fitting), the clip 60 is removed from the fitting, the fitting is moved axially forward (inwardly) to remove the pins 52 from the serif portion 36A, then the fitting is rotated (e.g., in the counterclockwise direction) to align the pins 52 with the ingress portions 34. With the pins 52 aligned with the ingress portions 34, the fitting 22 is moved axially forward (e.g., outwardly) to withdraw the fitting from the port 20.

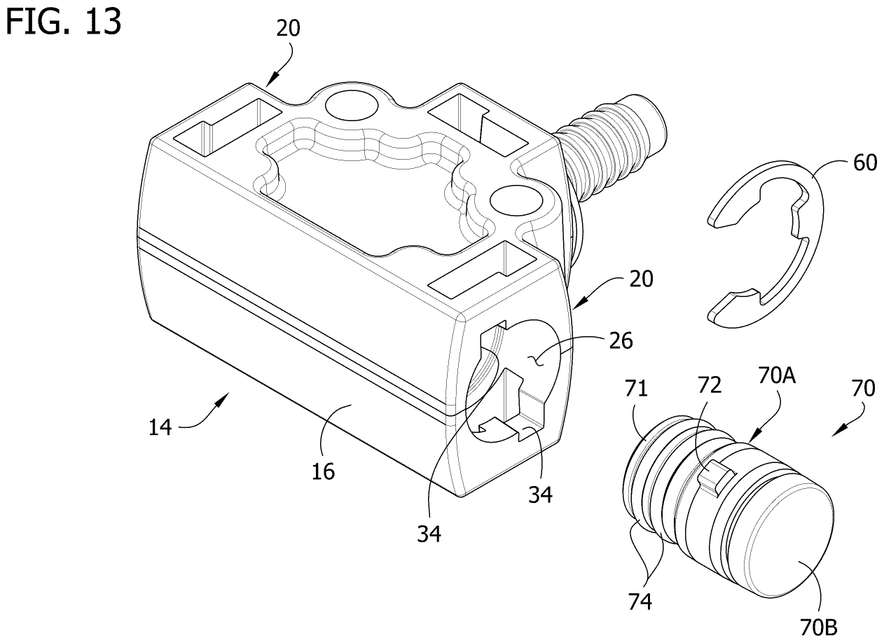

As explained above, one or more of the ports 20 of the manifold 14 may be plugged. In the illustrated embodiment shown in FIGS. 1 and 13, a plug 70 is sealingly connected to one of the ports 20 in the same manner and design as the hose fitting 22. In particular, the plug 70 includes a manifold connector 70A that is the same design and constructions as the manifold connector 22B and a plug body 70B. In particular, the manifold connector 70A includes a body 71, one or more bayonet pins 72, and one or more seals 74 (e.g., O-rings) on the body. Unlike the hose fitting 22, the plug 70 does not include a fluid passage or a hose connector. The same clip 60 is used to lock the plug 70 in the port 20.

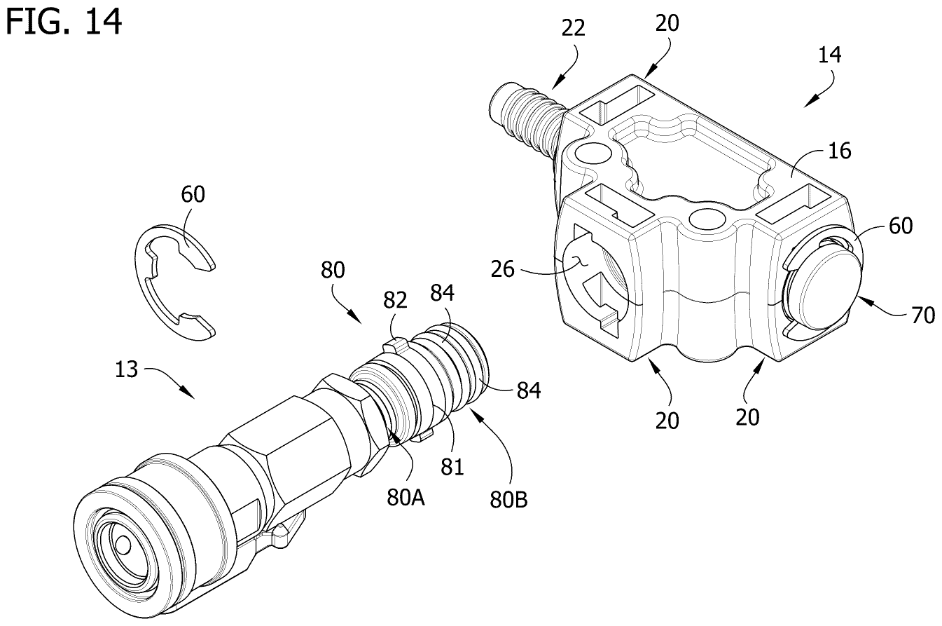

As explained above, other components, other than the hoses 12, may be coupled to the manifold 14. In the illustrated embodiment shown in FIGS. 1 and 14, a gas tank coupler 13 is sealingly connected to one of the ports 20 using a fitting 80 which is similar to the hose fitting 22. In particular, the gas tank coupler 13 includes a gas coupler connector 80A which threads into the gas tank coupler 13, and a manifold connector 80B that is the same design and construction as the manifold connector 22B. In particular, the manifold connector 80B includes a body 81, one or more bayonet pins 82, and one or more seals 84 (e.g., O-rings) on the body.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A manifold for a gas distribution system comprising:
a manifold body defining a manifold passage; and
a plurality of ports on the manifold body, wherein each of the plurality of ports defines i) a port opening extending through a front of the port to and in communication with the manifold passage, and ii) at least one bayonet slot extending from and in registration with the port opening;
wherein the port opening is configured to axially receive a fitting;
wherein the at least one bayonet slot is configured to receive at least one bayonet pin from a manifold connector of the fitting and enable rotational movement of the at least one pin in the bayonet slot to connect the fitting to the port.

2. The manifold of claim 1, wherein the at least one bayonet slot comprises a transverse locking portion extending circumferentially around a portion of the port opening and a serif portion extending longitudinally along a portion of the port opening.

3. The manifold of claim 2, wherein the serif portion is configured to permit partial retraction of the fitting while the bayonet pin aligned therewith, and wherein the fitting is rotatably fixed within the port when partially retracted into the serif portion.

4. The manifold of claim 3, further comprising a clip configured to detachably couple to the fitting at a circumferential channel thereof when the fitting is partially retracted, such that the fitting is at a locked position within the manifold.

5. The manifold of claim 1, wherein each of the plurality of ports includes a substantially cylindrical internal surface configured to sealingly interface with an annular seal of the fitting.

6. The manifold of claim 1, wherein each of the plurality of ports defines two diametrically opposed bayonet slots.

7. The manifold of claim 1, wherein the plurality of ports includes two coaxial end ports on opposing ends of the manifold and two parallel ports on a shared side of the manifold.

8. The manifold of claim 1, in combination with the fitting, wherein the fitting is received in the port opening, and wherein the at least one bayonet pin from the manifold connector of the fitting is received in the at least one bayonet slot.

9. A fitting for a port of a manifold of a gas distribution system, the fitting comprising:
opposite proximal and distal end portions; and
a manifold connector at the distal end portion of the fitting, the manifold connector including:
a generally cylindrical connector body configured to be received in a port opening of the port of the manifold;
at least one bayonet pin extending radially outward from the connector body configured to be received in at least one bayonet slot extending from and in registration with the port opening; and
at least one annular seal on the connector body disposed distal of the at least one bayonet pin.

10. The fitting of claim 9, wherein the at least one annular seal is configured to form a sealed connection with an interior surface of the port when the fitting is retained therein.

11. The fitting of claim 10, further comprising a plurality of annular ribs spaced apart longitudinally from one another at the proximal end portion of the fitting, wherein the plurality of annular ribs are configured to be received in a gas hose.

12. The fitting of claim 11, wherein the fitting defines a substantially cylindrical fluid passage for forming a fluid connection between the gas hose and a manifold passage of the manifold.

13. The fitting of claim 10, further comprising a plug body at the proximal end portion of the fitting.

14. The fitting of claim 10, further comprising, at the proximal end portion of the fitting: a gas coupler connector for connecting the fitting to a gas tank; and a valve for selectively controlling a flow of gas through the fitting.

15. The fitting of claim 10, wherein the fitting defines a circumferential channel configured to releasably retain a clip for locking the fitting within the port, wherein the circumferential channel is proximal of the at least one bayonet pin.

16. A gas distribution system comprising:
a plurality of manifolds, each manifold including:
a manifold body defining a manifold passage;
a plurality of ports on the manifold body, wherein each of the plurality of ports defines i) a port opening extending through a front of the port to and in communication with the manifold passage, and ii) at least one bayonet slot extending from and in registration with the port opening; and
a plurality of hoses connected to the plurality of manifolds, wherein each hose includes
a hose body having opposite longitudinal ends;
a fitting having opposite proximal and distal end portions, the fitting including a hose connector at the proximal end portion of the fitting and connected to one of the longitudinal ends of the hose body, and a manifold connector at the distal end portion of the fitting, wherein the manifold connector includes a generally cylindrical connector body received in the port opening of one of the ports of the manifold, at least one bayonet pin extending radially outward from the connector body and received in at least one bayonet slot extending from and in registration with the port opening, and at least one annular seal on the connector body sealingly engaging an interior of the port defining the port opening.

17. The gas distribution system of claim 16, wherein the at least one bayonet slot includes a transverse locking portion extending circumferentially around a portion of the port opening, and a serif portion extending longitudinally along a portion of the port opening, wherein the serif portion is configured to permit partial retraction of the fitting while the bayonet pin is aligned therewith, and wherein the fitting is rotatably fixed within the port when partially retracted within the serif portion.

18. The gas distribution system of claim 17, wherein the fitting defines a circumferential channel configured to releasably retain a clip for locking the fitting within the port, the circumferential channel being defined proximal of the at least one bayonet pin.

19. The gas distribution system of claim 17, wherein at least one of the plurality of manifolds is fitted with a fitting having a gas coupler connector configured to sealingly connect to a gas tank such that the gas distribution system is in fluid communication therewith.

20. The gas distribution system of claim 17, in combination with a recreational vehicle, wherein the gas distribution system is retained on the recreational vehicle for use in selectively distributing propane to gas powered appliances of the recreational vehicle.
